(19) United States
(12) Patent Application Publication
(10) Pub. No.: US 2006/0224476 A1
(43) Pub. Date: Oct. 5, 2006

(54) Long distance trading system

(76) Inventor: Jerry Sung, Beverly Hills (AU)

Correspondence Address: LADAS & PARRY, 26 WEST 61ST STREET, NEW YORK, NY, 10023, US

(21) Appl. No.: 11/098,585

(22) Filed: Apr. 4, 2005

(51) Int. Cl. G07F 19/00; G06Q 40/00; G07B 17/00

(52) U.S. Cl. 705/30; 705/35

(57) ABSTRACT

The invention relates to a long distance trading system for carrying out a transaction via a platform between a seller and a buyer, wherein the seller and the buyer are far away from each other. The long distance trading system not only protects the seller of the goods by holding the goods at a location until the payment for the goods is settled, but also protects the buyer from paying money in advance before the goods are received so as to minimize the risk of the transaction to both the buyer and seller. In addition, the long distance trading system provides a variety of paying mechanisms.

### FIELD OF THE INVENTION

The present invention relates to the field of a trading system, and more particularly, to a long distance trading system for performing an online transaction between a seller and a buyer.

### BACKGROUND OF THE INVENTION

A typical online transaction, i.e., eBay or Yahoo, includes a buyer and a seller of goods. The buyer chooses/decides the goods that conform to his needs via the electrical platform. After both parties agree with the transaction, the buyer may be requested to pay in advance and the seller will deliver the goods through parcel services. Several disadvantages exist in the typical online transaction as described below. First of all, there is possibility that the buyer does not receive the goods even though he has paid for it and it takes more time and money to solve such fraud. Secondly, the goods received by the buyer may not conform to the buyer's need for two reasons: the goods are not the same as that shown on the online platform, or the goods are damaged during the delivery process. However, it is difficult to clear the responsibility. In some cases, the buyer and seller make a face-to-face appointment to delivery the goods and money at the time. The face-to-face appointment is inconvenient and dangerous, and it is even impossible that the buyer and the seller live in different countries far away from each other. In addition, there are only limited mechanisms for paying. For example, it is impossible to pay with credit card for customer-to-customer transactions.

Therefore, it would be advantageous to have a trading system for carry out the transaction wherein the seller and the buyer are far from each other. It would be further advantageous to have a trading system providing a variety of paying mechanisms. It would also be advantageous to have a trading system that permits the buyer to confirm the goods personally.

### SUMMARY OF THE INVENTION

The claimed invention relates to a trading system for carrying out a transaction between a seller and a buyer, wherein the seller and the buyer are far away from each other. The long distance trading system is not only limited to electrical commerce, and can also be applied to all kinds of long distance trading mechanisms, i.e., TV shopping or posting shopping. The trading system protects the seller of the goods by holding the goods at a location near the buyer until the payment for the goods is paid. The trading system also protects the buyer from paying money in advance before the goods are received. In addition, the buyer can check the goods personally even if the seller is far away from the buyer. The buyer can take away the goods if the goods conform to the buyer's need, and can even returns the goods if the goods are not what the buyer wishes to buy. Especially, the trading system provides a variety of paying mechanisms.

In one embodiment, the claimed invention provides a trading system for carrying out a transaction between a seller and a buyer via a platform, wherein the transaction includes delivering an object from a first location to a second location. Firstly, the buyer and the seller join the transaction on the platform after agreeing with the objects and the payment. A source unit is located in the said first location for receiving an order message from the platform that indicates the transaction, and for generating a delivery message while receiving the object from the seller. A destination unit is located in the said second location for receiving the order message that indicates the transaction, and for generating a payment message when receiving the payment from the said second location. The order message is used as a reference information for generating the said delivery message and the said payment message, the said delivery message is used as a reference information when transmitting the object from the first location to the second location, and the said payment message is used for determining whether a payment amount necessary to allow the buyer to get the object is paid. The trading system is configured to provide a variety of paying mechanisms for the buyer to pay the payment amount. After the payment amount is paid in the destination unit, the platform is configured to send a releasing message to the destination unit and the buyer can take the object away.

In another aspect, the claimed invention provides a further trading system for carrying out a transaction, between two parties via a platform, wherein the transaction includes delivering objects between a first location and a second location. Firstly, both of the parties join the transaction on the platform after agreeing with the objects to be exchanged. In some cases, the payment is needed for compensating the price difference of the exchanging objects. The party that owns the object with higher value is defined as “the seller.” The party who has to pay the price difference is defined as “the buyer.” In this case, the order messages are sent to both parties and then both of the parties deliver the objects to the locations that are respectively close to them. The exchanged objects are exchanged via the platform, source unit and the destination unit. The buyer has to pay the price difference in the second location. After the payment is paid and both parties agree to the objects, the objects are allowed to be released.

The delivery process, i.e., the seller to the first location, the first location to the second location, and the second location to the buyer, of the trading system may be performed separately by another distribution service.

### BRIEF DESCRIPTION OF THE DRAWING

FIG. 1 is a schematic diagram of a long distance trading system with object and message flow according to one embodiment of the present invention.

FIG. 2 is a schematic diagram of a long distance trading system with platform, destination unit and source unit according to one embodiment of the present invention.

FIG. 3 is a flow diagram showing a long distance trading method employing the trading system of FIGS. 1 and 2.

### DETAILED DESCRIPTION OF THE INVENTION

The present invention will now be described in more detail hereinafter with reference to the drawings, in which preferred embodiments of the invention are shown. This invention may be embodied in many different forms and should not be constructed as being limited to the embodiments set forth herein.

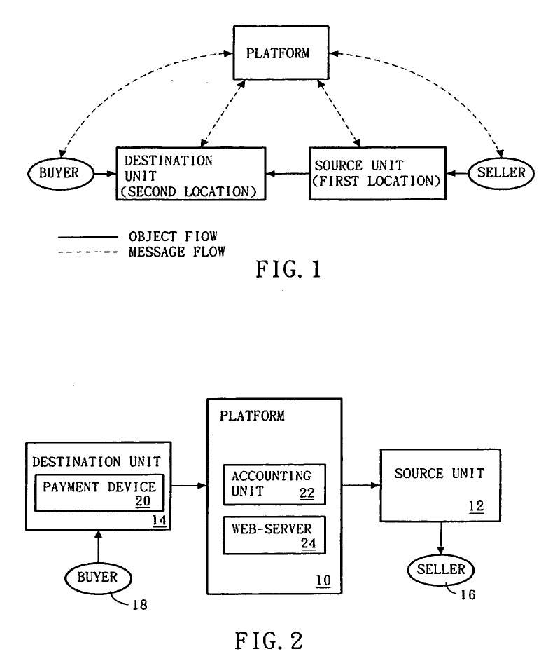

In a preferred embodiment, the present invention provides a trading system 100 for proceeding with a transaction between a seller 16 and a buyer 18 via a platform 10, wherein the transaction includes delivering an object from a first location to a second location. The trading system 100 is especially useful for long-distance transaction, i.e., for transactions between a seller 16 in a first country and a buyer 18 in a different country. The trading system 100 preferably includes a platform 10, a source unit 12 located in the first location and a destination unit 14 located in the second location, as shown in FIG. 1. The location of the seller is close to the first location and the location of the buyer is close to the second location. Firstly, the buyer 18 and the seller 16 join the transaction on the platform 10 after agreeing with the objects and the payment. They can come into agreement in any other platforms, such as electrical commerce, TV shopping or posting shopping. The seller 16 first need to register his own personal details on the trading system 100. It is optional for the buyer 18 to register. The seller 16 will then provide the details and the price of the object to be traded. Moreover, the seller 16 will provide the account name of the buyer 18 if the buyer 18 is a registered user or the seller 16 will provide the personal details of the buyer 18 if the buyer 18 is not a registered user. The platform generates and sends the order message that indicates the transaction to a source unit 12 and a destination unit 14. The platform 10 also generates and sends the delivery notification to the seller 16 to notify the seller 16 to deliver the object to the first location. The source unit 12 is also responsible for generating an object receipt for the seller 16 to prove that the object has indeed been delivered. When receiving the object from the seller 16, the source unit 12 located in the first location generates a delivery message by referencing to the order message and sends the delivery message to the platform 10. The platform 10 sends a pick-up message, which is for notifying the buyer 18 to pick up the object from the second location, to the buyer 18 after receiving the delivery message. As shown in FIG. 2, the destination unit 14 further comprises a payment device 20 for receiving a payment from a buyer 18 according to the order message, wherein the payment device 20 is operational through a number of paying mechanisms. Examples of aforementioned paying mechanisms include, but not limited to, cash, credit card system, paypal, escrow or, ezpay. Persons skilled in the art should adopt any other mechanism that provides the same or similar functions. The destination unit 14 generates a payment message after the buyer pays the payment for the transaction through the payment device 20, and the payment message is sent to the platform 10. As shown in FIG. 2, the platform 10 further comprises an accounting unit 22 for settling a payment to the seller after receiving the payment message from the destination unit 14, wherein the accounting unit 22 is operational through a number of paying mechanisms. After the payment for the seller 16 is settled, the platform 10 sends a releasing message for notifying the destination unit 14 to release the object to the buyer 18. The corresponding object flow and message flow are shown in FIG. 1, and the corresponding payment flow is shown in FIG. 2.

In a second preferred embodiment, the present invention includes a trading system 100 for proceeding with a transaction between two parties via a platform 10, wherein the transaction includes exchanging objects between a first location and a second location. In the exchanging cases, the payment includes paying for compensating the price difference of the exchanging objects. For simplicity, the party that owns the object with higher value is hereinafter defined as “the seller,” and the party who has to pay the price difference is hereinafter defined as “the buyer.” They can come into agreement of exchanging objects in any platforms, such as electrical commerce or online forums. The seller 16 and buyer 18 both need to register their own personal details on the trading system 100. The seller 16 needs to provide the exchanging details, including the details of the objects to be exchanged, whether any price difference needs to be paid for compensation, and the account name of the buyer 18. The trading system 100 preferably includes a platform 10, a source unit 12 located in the first location and a destination unit 14 located in the second location. Firstly, the buyer 18 and the seller 16 join the transaction on the platform 10 after agreeing with the objects and the payment. The platform generates and sends the order message that indicates the transaction to a source unit 12 and a destination unit 14. The platform 10 also generates and sends the delivery notification to the seller 16 and the buyer 18 to notify the seller 16 and the buyer 18 to deliver the objects to the first location and second location, respectively. The source unit 12 is also responsible for generating an object receipt for the seller 16 to prove that the object is indeed delivered. The destination unit 14 is also responsible for generating an object receipt for the buyer 18 to prove that the object is indeed delivered. When receiving the object from the seller 16 and the buyer 18, the source unit 12 and the destination unit 14 generate a delivery message by referencing to the order message and send the delivery message to the platform 10. The platform 10 sends pick-up messages, which is for notifying the seller 16 and the buyer 18 to pick up the object from the first and second locations, to the seller 16 and the buyer 18 after receiving the delivery message. Since the buyer 18 has to pay the price difference for the object exchanged, the payment device 20 is responsible for receiving a payment from a buyer 18 according to the order message, wherein the payment device 20 is operational through a number of paying mechanisms. Examples of aforementioned paying mechanisms include, but not limited to, cash, credit card system, paypal, escrow or, ezpay. Persons skilled in the art should adopt any other mechanism that provides the same or similar functions. The destination unit 14 generates a payment message after the buyer pays the payment for the transaction through the payment device 20, and the payment message is sent to the platform 10. The platform 10 further comprises an accounting unit 22 for settling a payment to the seller 16 after receiving the payment message from the destination unit 14, wherein the accounting unit 22 is operational through a number of paying mechanisms. After the payment for the seller 16 is settled, the platform 10 sends a releasing message for notifying the destination unit 14 to release the object. In addition, the platform 10 also sends a releasing message to the source unit 12 for notifying the source unit 12 to release the object to the seller 16.

In another embodiment, the delivery process, i.e., the seller 16 to the first location, the first location to the second location, and the second location to the buyer 18, of the trading system may employ another party to transport the objects between the locations.

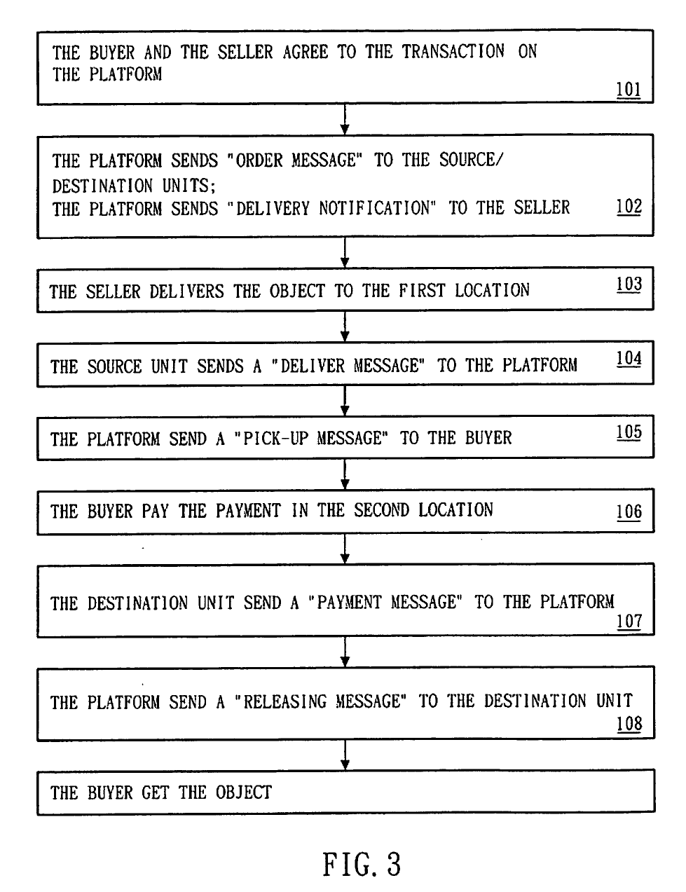

The trading system 100 of the present invention is used to complete a transaction between the seller 16 and the buyer 18, as shown in FIG. 3. After the buyer 18 and the seller 16 agree to the transactions 101, the platform 10 sends order message to the source and destination units 102, and the platform 10 also sends delivery notification to the seller 102. The seller 16 then delivers the object to the first location 103. After receiving the object from the seller 16, the source unit 12 sends a delivery message to the platform 104. Upon receiving the delivery message, the platform 10 sends a pick-up message to the buyer 105. The buyer 18 can pay the payment in the second location 106 and the destination unit 14 would send a payment message to the platform 107. The platform 10 sends a releasing message to the destination unit 108 and the buyer 18 can obtain the object.

Although the preferred embodiments of FIGS. 1 and 2 involve a long distance trading system, it should be understood that the present invention can also be applied to transaction where the seller 16 and buyer 18 are close to each other geographically. In such a case, the seller 16 drops off the goods at the first location, and the buyer 18 can pay the payment in the same location with payment device 20.

The present invention has several advantages. The possibility of fraud in online commerce is significantly decreased. The buyer 18 can verify if the object he ordered conforms to his need, and even can reject the object without paying the payment in advance. The seller 16 is also protected since the object will not be delivered to the buyer 18 until the payment is settled. In addition, such long distance trading system makes the electrical commerce transaction more convenient. The trading system further provides a variety of paying mechanisms, which are especially convenient for customer-to-customer business. The present invention plays a role that is similar to a “bridge” between a seller 16 and a buyer 18. The trading system coordinates the delivery, payment and verification of object, and the coordination eliminates the inconvenience, fraud and danger that happen frequently in electrical transactions.

1. A system for proceeding with a transaction between a seller and a buyer via a platform, wherein the transaction comprises delivering an object from a first location to a second location, said system comprising:
a source unit located in the said first location for receiving an order message from the platform that indicates the transaction, and for generating a delivery message when receiving the object from the seller; and
a destination unit located in the said second location for receiving the order message that indicates the transaction, and for generating a payment message when receiving the payment from the said second location;
wherein the said order message is utilized as a reference information for generating the said delivery message and the said payment message, the said delivery message is utilized as a reference information when transmitting the object from the first location to the second location, and the said payment message is utilized for determining whether a payment amount necessary to allow the buyer to obtain the object is paid.

2. The system of claim 1, wherein the platform generates a delivery notification to the said seller to notify the said seller to deliver the object to the first location.

3. The system of claim 2, wherein the said source unit generates an object receipt for the said seller to prove that the object has been delivered.

4. The system of claim 3, wherein the platform generates a pick-up message for notifying the said buyer to pick up the said object from the said second location.

5. The system of claim 4, further comprising a payment device for receiving a payment from a buyer according to the said order message.

6. The system of claim 5, wherein the payment device is operational through a number of paying mechanisms.

7. The system of claim 6, wherein the paying mechanisms include paying by cash or credit card.

8. The system of claim 7, wherein the platform further comprises an accounting unit for settling a payment to the said seller responsive to receiving a payment message from the said destination unit.

9. The system of claim 8, wherein the said accounting unit for paying a payment is operational through a number of paying mechanisms.

10. The system of claim 9, wherein the platform generates a releasing message responsive to the said payment message to notify the said destination unit in the second location to release the object.
